(19) United States
(12) Patent Application Publication
(10) Pub. No.: US 2024/0332676 A1
(43) Pub. Date: Oct. 3, 2024

(54) SOLID OXIDE CELL STACK

(71) Applicant: SAMSUNG ELECTRO-MECHANICS CO., LTD., Suwon-si (KR)

(72) Inventors: Jaeseok Yi, Suwon-si (KR); Jung Deok Park, Suwon-si (KR); Hong Ryul Lee, Suwon-si (KR); Jeong Suong Yang, Suwon-si (KR); Byung Chul Jang, Suwon-si (KR); Dong Jin Kim, Suwon-si (KR)

(73) Assignee: SAMSUNG ELECTRO-MECHANICS CO., LTD., Suwon-si (KR)

(21) Appl. No.: 18/232,597

(22) Filed: Aug. 10, 2023

(30) Foreign Application Priority Data
Mar. 31, 2023 (KR) 10-2023-0042998

(51) Int. Cl. H01M 12/06; H01M 4/90

(52) U.S. Cl. CPC H01M 12/065; H01M 4/9025; H01M 4/905; H01M 2300/0074

(57) ABSTRACT

A solid oxide cell stack includes a plurality of interconnects, a first solid oxide cell disposed between the plurality of interconnects and including a first fuel electrode, a first electrolyte, and a first air electrode, and a second solid oxide cell disposed to be adjacent to the first solid oxide cell in a lateral direction between the plurality of interconnects and including a second fuel electrode, a second electrolyte, and a second air electrode, wherein an operating temperature of the first solid oxide cell is higher than an operating temperature of the second solid oxide cell.

### CROSS-REFERENCE TO RELATED APPLICATION (S)

This application claims benefit of priority to Korean Patent Application No. 10-2023-0042998 filed on Mar. 31, 2023 in the Korean Intellectual Property Office, the disclosure of which is incorporated herein by reference in its entirety.

### TECHNICAL FIELD

The present disclosure relates to a solid oxide cell stack.

### BACKGROUND

A solid oxide fuel cell (SOFC) and a solid oxide electrolysis cell (SOEC) may include a cell formed of an air electrode, a fuel electrode, and a solid electrolyte having oxygen ion conductivity, and here, the cell may be referred to as a solid oxide cell. The solid oxide cell may produce electrical energy through an electrochemical reaction or may electrolyze water through a reverse reaction of a solid oxide fuel cell to produce hydrogen. Compared to other types of fuel cells or electrolysis cells, such as phosphoric acid fuel cells (PAFC), alkali fuel cells (AFC), polymer electrolyte membrane fuel cells (PEMFC), and direct methanol fuel cells (DMFC), solid oxide cells are based on low activation polarization to have a low overvoltage and have low irreversible loss to have high efficiency. In addition, the solid oxide cells may be used as a carbon or hydrocarbon-based fuel, as well as hydrogen, thus having a wide range of fuel selection, and has a high reaction rate in electrode, thereby not requiring expensive precious metals as an electrode catalyst.

Meanwhile, the solid oxide cell may be used in a stack structure disposed between a pair of interconnects. In the solid oxide cell stack, in order to efficiently use fuel and heat, a method of reusing fuel and heat by re-injecting gas after a reaction into the same stack or another stack through reprocessing has been used. This method requires a waste heat recovery system collecting waste heat and adjusts the waste heat to an appropriate temperature or a reforming system for changing a concentration of gas, which may reduce the efficiency of the solid oxide cell stack.

### SUMMARY

Exemplary embodiments provide a solid oxide cell stack having improved fuel and heat use efficiency.

According to an aspect of the present disclosure, a solid oxide cell stack includes: a plurality of interconnects; a first solid oxide cell disposed between the plurality of interconnects and including a first fuel electrode, a first electrolyte, and a first air electrode; and a second solid oxide cell disposed to be adjacent to the first solid oxide cell in a lateral direction between the plurality of interconnects and including a second fuel electrode, a second electrolyte, and a second air electrode. An operating temperature of the first solid oxide cell is higher than an operating temperature of the second solid oxide cell.

The operating temperature of the first solid oxide cell may be 750° C. or higher, and the operating temperature of the second solid oxide cell is less than 750° C.

The first solid oxide cell may be an electrolyte-supported cell, and the second solid oxide cell is a fuel electrode-supported cell.

The second electrolyte may be thinner than the first electrolyte.

The first and second fuel electrodes may include Ni and YSZ.

The first fuel electrode may have a lower content ratio of Ni than the second fuel electrode.

The first and second electrolytes may have substantially a same thickness.

The first and second air electrodes may include different materials.

The first air electrode may include a LaMg-based ceramic, and the second air electrode includes LaCo-based ceramics.

The first and second electrolytes may have substantially a same thickness.

The first and second electrolytes may be connected to each other to have an integral structure.

The second electrolyte may be thinner than the first electrolyte.

When a stacking direction of the plurality of interconnectors is referred to as a first direction, the first and second solid oxide cells may be arranged to be adjacent to each other in a second direction, perpendicular to the first direction.

The plurality of interconnects may include first and second recesses in which the first and second solid oxide cells are respectively disposed.

The first and second recesses may be connected to each other.

The first fuel electrode may face a bottom surface of the first recess, and the second fuel electrode may face a bottom surface of the second recess.

The plurality of interconnects may include a plurality of through-holes extending in a stacking direction of the plurality of interconnectors, and the plurality of through-holes are arranged outside of the first and second recesses.

Some of the plurality of through-holes may be connected to the first recess and the others thereof may be connected to the second recess.

According to another aspect of the present disclosure, a solid oxide cell stack includes: a plurality of interconnects; an electrolyte-supported first solid oxide cell disposed between the plurality of interconnects; and a fuel electrode-supported second solid oxide cell disposed between the plurality of interconnects.

When a stacking direction of the plurality of interconnectors is referred to as a first direction, the first and second solid oxide cells may be disposed to be adjacent to each other in a second direction, perpendicular to the first direction.

According to an aspect of the present disclosure, a solid oxide cell stack includes: a plurality of interconnects; a first solid oxide cell disposed between the plurality of interconnects and including a first fuel electrode, a first electrolyte, and a first air electrode arranged in a first direction; and a second solid oxide cell disposed between the plurality of interconnects and including a second fuel electrode, a second electrolyte, and a second air electrode arranged in the first direction. The first solid oxide cell and the second solid oxide cell are disposed in a second direction crossing the first direction. The first solid oxide cell and the second solid oxide cell are different from each other at least in one of the following: thickness between the first electrolyte and the second electrolyte, material composition between the first fuel electrode and the second fuel electrode, and material composition between the first air electrode and the second air electrode.

The first and second fuel electrodes may include Ni and YSZ, and the first fuel electrode may have a lower content ratio of Ni than the second fuel electrode.

The first air electrode may include a LaMg-based ceramic, and the second air electrode may include LaCo-based ceramics.

The first and second electrolytes may be connected to each other to have an integral structure.

The first and second electrolytes may be spaced apart from each other.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a solid oxide cell stack according to an exemplary embodiment in the present disclosure;

FIG. 2 is an exploded perspective view schematically illustrating the solid oxide cell stack of FIG. 1;

FIG. 3 is a cross-sectional view schematically illustrating an example of a first solid oxide cell;

FIG. 4 is a cross-sectional view schematically illustrating an example of a second solid oxide cell;

FIG. 5 is a schematic cross-sectional view of the solid oxide cell stack of FIG. 1;

FIG. 6 is a cross-sectional view schematically illustrating another example of first and second solid oxide cells;

FIG. 7 is a schematic cross-sectional view illustrating another example of first and second solid oxide cells;

FIG. 8 is an exploded perspective view schematically illustrating a solid oxide cell stack according to another exemplary embodiment in the present disclosure;

FIG. 9 is a schematic cross-sectional view illustrating the solid oxide cell stack of FIG. 8; and

FIG. 10 is a cross-sectional view schematically illustrating an example of first and second solid oxide cells that may be employed in the exemplary embodiment of FIG. 8.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising”, will be understood to imply the inclusion of stated elements but not the exclusion of any other elements.

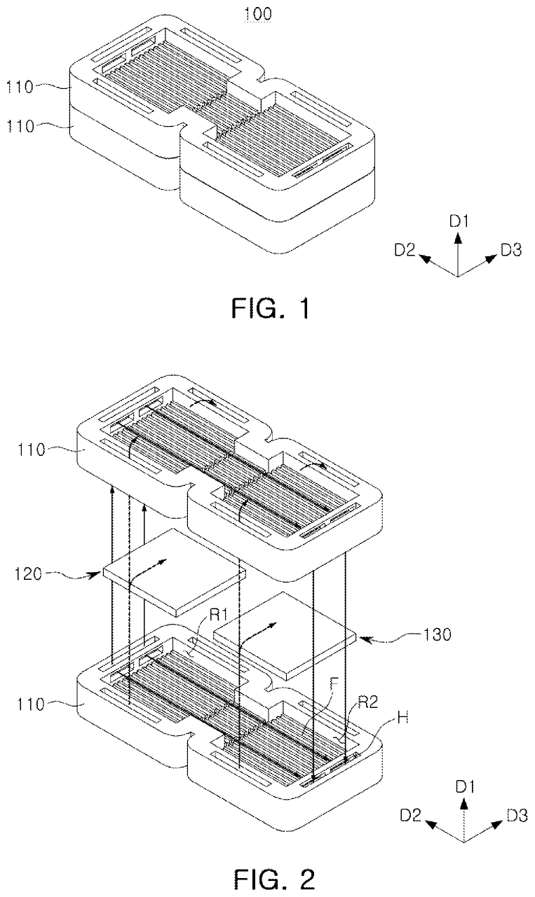

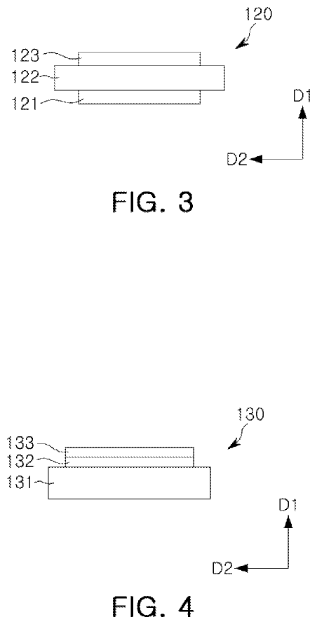

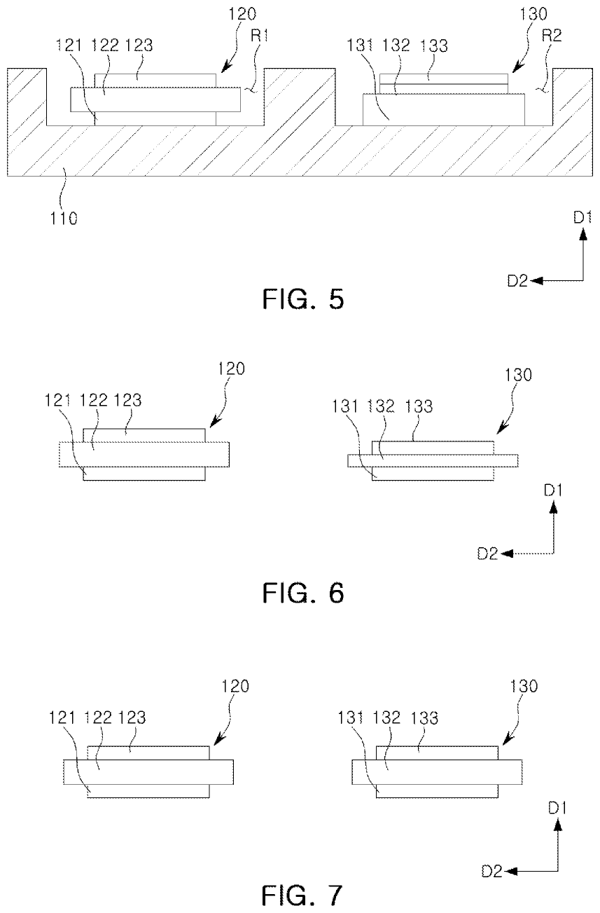

FIGS. 1 and 2 schematically illustrate a solid oxide cell stack according to an exemplary embodiment in the present disclosure, and correspond to a perspective view and an exploded perspective view, respectively. FIGS. 3 and 4 are cross-sectional views schematically illustrating examples of first and second solid oxide cells, respectively. FIG. 5 is a schematic cross-sectional view of the solid oxide cell stack of FIG. 1.

Referring to FIGS. 1 to 5, a solid oxide cell stack 100 according to an exemplary embodiment in the present disclosure includes, as main components, a plurality of interconnects 110, a first solid oxide cell 120, and a second solid oxide cell 130 disposed to be adjacent the first solid oxide cell 120 in a lateral direction, and here, an operating temperature of the first solid oxide cell 120 is higher than that of the second solid oxide cell 130. As in the present exemplary embodiment, by using the solid oxide cells 120 and 130 having different operating temperatures in the single solid oxide cell stack 100, a utilization rate of fuel and heat may be significantly improved. That is, unlike a stack including only cells having the same characteristics which have efficiency decreasing as a reaction progresses during driving, in the exemplary embodiment in the present disclosure, high efficiency may be maintained during driving by effectively arranging the cells 120 and 130 having different optimal driving conditions. Hereinafter, components of the solid oxide cell stack 100 will be described in detail.

The plurality of interconnects 110 may be formed of a material having excellent electrical conductivity and a low degree of degradation in a high-temperature environment. As a specific example, the plurality of interconnects 110 may be formed of a metal, such as stainless, nickel, iron, or copper. The plurality of interconnects 110 may be electrically connected to the first and second solid oxide cells 120 and 130. In this case, a plurality of first and second solid oxide cells 120 and 130 may be provided and implemented as a stacked structure. In other words, the first and second solid oxide cells 120 and 130 may be disposed on the upper interconnect 110 among the plurality of interconnects 110, and three or more interconnects 110 may be repeatedly stacked. The plurality of interconnects 110 may have a flat plate structure and may also include recesses R1 and R2 in which the solid oxide cells 120 and 130 may be disposed or flow path F, through-hole H in which fuel and air may diffuse. As will be described below, these additional elements of the interconnect 110 may facilitate fluid flow between the first and second solid oxide cells 120 and 130 having different driving characteristics, thereby obtaining high efficiency.

The first solid oxide cell 120 and the second solid oxide cell 130 may be disposed between the plurality of interconnects 110 and may correspond to functional layers of a fuel cell or an electrolysis cell. In this case, the first and second solid oxide cells 120 and 130 may be disposed in the first and second recesses R1 and R2 of the interconnect 110, and the flow path F may be formed in the first and second recesses R1 and R2 of the interconnect 110. A driving temperature of the first solid oxide cell 120 may be higher than an operating temperature of the second solid oxide cell 130, and such driving conditions may be implemented through specific exemplary embodiments in the present disclosure as will be described below. Referring to FIG. 3, the first solid oxide cell 120 may include a first fuel electrode 121, a first electrolyte 122, and a first air electrode 123. In this case, the first electrolyte 122 may be disposed between the first fuel electrode 121 and the first air electrode 123. Also, referring to FIG. 4, the second solid oxide cell 130 may include a second fuel electrode 131, a second electrolyte 132, and a second air electrode 133. In this case, the second electrolyte 132 may be disposed between the second fuel electrode 131 and the second air electrode 133. Also, as illustrated in FIG. 5, the first solid oxide cell 120 may be disposed such that the first fuel electrode 121 faces a bottom surface of the first recess R1, and similarly, the second solid oxide cell 120 may be disposed such that the second fuel electrode 131 faces a bottom surface of the second recess R2.

When used as a fuel cell, water may be generated due to oxidation of hydrogen or an oxidation reaction of carbon compounds may occur in the fuel electrodes 121 and 131, and oxygen ion generation reaction may occur due to decomposition of oxygen in the air electrodes 123 and 133. When used as an electrolysis cell, a reaction opposite thereto may occur. For example, hydrogen gas may be generated according to a reduction reaction of water in the fuel electrodes 121 and 131, and oxygen may be generated in the air electrodes 123 and 133. As another example, when used as a fuel cell, hydrogen decomposition (generation of hydrogen ions) reaction may occur in the fuel electrodes 121 and 131, and oxygen and hydrogen ions may be combined in the air electrodes 123 and 133 to generate water. In the case of an electrolysis cell, a decomposition reaction of water (generation of hydrogen and oxygen ions) may occur in the fuel electrodes 121 and 131, and oxygen may be generated in the air electrodes 123 and 133. In addition, ions may move from the first electrolyte 122 to the first fuel electrode 121 or the first air electrode 123, and from the second electrolyte 132 to the second fuel electrode 131 or the second air electrode 133.

Components of the first and second solid oxide cells 120 and 130, that is, the first and second fuel electrodes 121 and 131, the first and second electrolytes 122 and 132, and the first and second air electrodes 123 and 133 may include a solid oxide. Specifically, the first and second fuel electrodes 121 and 131 may include a cermet layer including a metal-containing phase and a ceramic phase. Here, the metal-containing phase may include a metal catalyst, such as nickel (Ni), cobalt (Co), copper (Cu), or alloys thereof, which acts as an electron conductor. The metal catalyst may be in a metallic state or may be in an oxide state. In the case of the ceramic phase of the first and second fuel electrodes 121 and 131, gadolinia doped ceria (GDC), samaria doped ceria (SDC), ytterbia doped ceria (YDC), scandia stabilized zirconia (SSZ), ytterbia ceria scandia stabilized zirconia (YbCSSZ), and the like.

The first and second electrolytes 122 and 132 may include stabilized zirconia. Specifically, the first and second electrolytes 122 and 132 may include scandia stabilized zirconia (SSZ), yttria stabilized zirconia (YSZ), scandia ceria stabilized zirconia (SCSZ), scandia ceria yttria stabilized zirconia (SCYSZ), and scandia ceria ytterbia stabilized zirconia (SCYbSZ), and the like.

The first and second air electrodes 123 and 133 may include an electrically conductive material, for example, an electrically conductive perovskite material, such as lanthanum strontium manganate (LSM). Other conductive perovskites, for example, metals, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or Pt may also be used. In some exemplary embodiments, the first and second air electrodes 123 and 133 may include a mixture of an electrically conductive material and an ionically conductive ceramic material. For example, the first and second air electrodes 123 and 133 may include about 10 wt % to about 90 wt % of an electrically conductive material (e.g., LSM, etc.) and about 10 wt % to about 90 wt % of an ion conductive material. Here, the ion conductive material may include zirconia-based and/or ceria-based materials.

Meanwhile, although the present exemplary embodiment illustrates an example in which two solid oxide cells 120 and 130 are disposed between the plurality of interconnects 110, a larger number of solid oxide cells (i.e., three or more) may also be disposed as needed. In this case, the shape of the interconnect 110 may be appropriately modified accordingly. When the number of solid oxide cells 120 and 130 is three or more, operating temperatures of at least two solid oxide cells 120 and 130 may be different.

In the case of the present exemplary embodiment, as described above, the operating temperature of the first solid oxide cell 120 may be higher than the operating temperature of the second solid oxide cell 130, and here, the operating temperature of the solid oxide cells 120 and 130 may be an optimal operating temperature with high power generation efficiency or electromotive efficiency. As a specific example, the operating temperature of the first solid oxide cell 120 may be 750° C. or higher, and the operating temperature of the second solid oxide cell 130 may be lower than 750° C. In FIG. 2, the arrows indicate flows of fuel and air when used as an electrolysis cell, and in detail, the solid lines indicate flows of fuel and the dotted lines indicate flows of air. As illustrated in FIG. 2, a temperature of the fuel that has passed through the first solid oxide cell 120 having a relatively high operating temperature is lowered due to an endothermic reaction when functioning as an electrolysis cell and partial pressure of the fuel is also lowered due to the use of the fuel. The fuel lowered in temperature and partial pressure may move to the second solid oxide cell 130 having a relatively low operating temperature, and a highly efficient reaction may occur in the second solid oxide cell 130. As in the present exemplary embodiment, a high-efficiency reaction may be maintained by arranging the solid oxide cells 120 and 130 having different operating temperatures adjacent to each other in the direction in which the fuel flows. In this case, the first and second solid oxide cells 120 and 130 may be disposed to be adjacent to each other in a lateral direction. More specifically, when a stacking direction of the plurality of interconnectors 110 is referred to as a first direction D1, the first and second solid oxide cells 120 and 130 may be disposed to be adjacent to each other in a second direction D2, perpendicular to the first direction D1.

As illustrated in FIG. 2, the first and second recesses R1 and R2 provided in the interconnect 110 may be provided to be connected to each other to facilitate the flow of fuel or air between the first and second solid oxide cells 120 and 130. In addition, the plurality of interconnects 110 may include a plurality of through-holes H formed in a thickness direction, that is, in the first direction D1 in the drawing. In this case, the plurality of through-holes H may be arranged outside the first and second recesses R1 and R2. Also, some of the plurality of through-holes H may be connected to the first recess R1 and others thereof may be connected to the second recess R2. Meanwhile, in the above, a case in which the solid oxide cell stack 100 functions as an electrolysis cell has been described, and when the solid oxide cell stack 100 functions as a fuel cell, the gradient of temperature or partial pressure of fuel may appear to be opposite.

As an example for differentiating operating temperatures of the first and second solid oxide cells 120 and 130, thicknesses of the electrolytes 122 and 132 respectively included in the first and second solid oxide cells 120 and 130 may be adjusted. More specifically, as illustrated in FIG. 3, the first solid oxide cell 120 may be a so-called an electrolyte-supported cell in which the first fuel electrode 121 and the first air electrode 123 are supported by the first electrolyte 122, and in this case, the first electrolyte 122 may be the thickest and the widest. Unlike this, in the case of the second solid oxide cell 130, as illustrated in FIG. 4, the second fuel electrode 131 may be the thickest fuel electrode-supported cell. Since the electrolytes 122 and 132 have relatively high electrical resistance, an operating temperature may increase when the electrolytes 122 and 132 are formed to be thick. Such an electrolyte-supported cell may be operated with high efficiency at high temperatures because the fuel electrode is relatively thin and stable against deterioration due to oxidation, that is, has excellent durability. Therefore, in the case of an electrolyte-supported cell, such as the first solid oxide cell 120, when the first electrolyte 122 is relatively thick, the operating temperature may be higher than that of the second solid oxide cell 130, and in the case of a fuel electrode-supported cell, such as the second solid oxide cell 130, ionic conductivity may be relatively high, so that the second solid oxide cell 130 may be driven with high efficiency even at low temperatures. However, the second solid oxide cell 130 may be implemented as a cell having a lower operating temperature, such as a metal-supported cell, rather than a fuel electrode-supported cell. Furthermore, the second solid oxide cell 130 may be a fuel electrode-supported cell and may additionally include a metal-supported cell or the like. Meanwhile, in the case of reliably realizing a difference in operating temperature by adopting different support type solid oxide cells 120 and 130 as in the present exemplary embodiment, it may not be necessary to limit the arrangement method of the first and second solid oxide cells 120 and 130 strictly to a form in which the first and second solid oxide cells 120 and 130 are spaced apart from each other in the lateral direction.

The first and second solid oxide cells according to a modified example will be described with reference to FIGS. 6 and 7. First, in the case of FIG. 6, the second electrolyte 132 corresponds to a structure thinner than the first electrolyte 122, regardless of the shape of the electrolyte-supported type or the fuel electrode-supported type. Accordingly, for the reasons described above, the operating temperature of the first metal oxide cell 120 may be higher than that of the second metal oxide cell 130. Next, in the case of FIG. 7, a difference in operating temperature between the first and second solid oxide cells 120 and 130 are realized using the material properties of the first and second fuel electrodes 121 and 131 and the first and second air electrodes 123 and 133. In this case, the first and second electrolytes 122 and 132 may have substantially the same thickness. First, the first and second fuel electrodes 121 and 131 may include Ni and YSZ, and a difference in operating temperature may be generated by changing a mixing ratio of Ni and YSZ. That is, as the ratio of Ni decreases and the ratio of YSZ increases, the operating temperature may increase, and thus, the first fuel electrode 121 may have a lower content ratio of Ni than that of the second fuel electrode 131. Here, the content ratio of Ni may refer to wt % and the Ni content in the first and second fuel electrodes 121 and 131 may be relatively measured, and thus, the content ratio of Ni may refer to mol % rather than wt %.

In the example of FIG. 7, materials of the first and second air electrodes 123 and 133 may be adjusted, and simultaneously or separately, materials of the first and second fuel electrodes 121 and 131 may also be adjusted. Specifically, the first and second air electrodes 123 and 133 may include different types of materials. More specifically, the first air electrode 123 may include a LaMg-based ceramic having a relatively high operating temperature, e.g., LSM, and the second air electrode 133 may include a LaCo-based ceramic a relatively low operating temperature, e.g., LSC.

As such, the difference in operating temperature between the first and second solid oxide cells 120 and 130 may be implemented by adjusting the materials of the first and second fuel electrodes 121 and 131 and the air electrodes 123 and 133 through the difference in thickness between the first and second electrolytes 122 and 132.

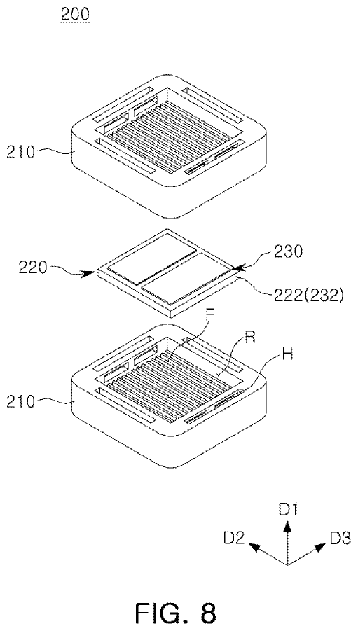

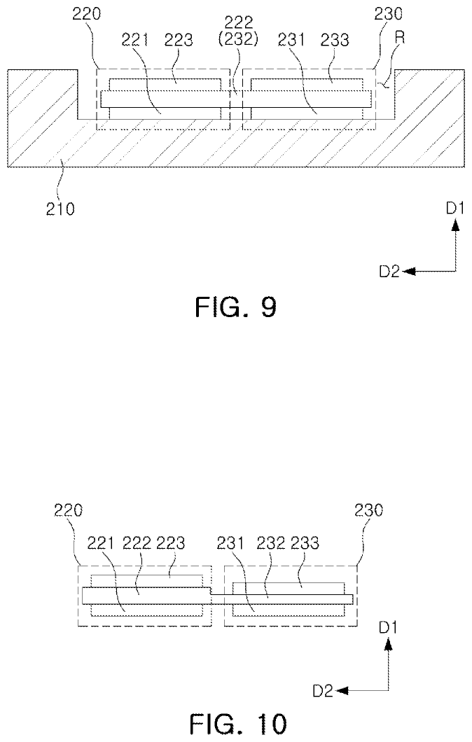

FIG. 8 is an exploded perspective view schematically illustrating a solid oxide cell stack according to another exemplary embodiment in the present disclosure, and FIG. 9 is a cross-sectional view schematically illustrating the solid oxide cell stack of FIG. 8. Also, FIG. 10 is a cross-sectional view schematically illustrating examples of first and second solid oxide cells that may be employed in the exemplary embodiment of FIG. 8.

Referring to FIGS. 8 to 10, in the present exemplary embodiment, a solid oxide cell stack 200 includes a plurality of interconnects 210, a first solid oxide cell 220, and a second solid oxide cell 230, as main components. Here, an operating temperature of the first solid oxide cell 220 is higher than an operating temperature of the second solid oxide cell 230. Unlike the previous exemplary embodiment, the first and second electrolytes 222 and 232 may be connected to each other to form an integral structure, and in this case, the first and second solid oxide cells 220 and 230 may be arranged in a single recess R provided in the interconnect 210. The first and second electrolytes 222 and 232 implemented as an integral structure as in the present exemplary embodiment may be advantageous in terms of manufacturing or handling the solid oxide cells 220 and 230 and may be appropriate for miniaturization of the solid oxide cell stack 200. In order to make the operating temperatures of the first and second solid oxide cells 220 and 230 different, materials of the fuel electrodes 221 and 231 and the air electrodes 223 and 233 may be adjusted or the thickness of the first and second electrolytes 222 and 232 may be adjusted in the same manner as described above.

For example, as in the example of FIG. 9, when the first and second electrolytes 222 and 232 have substantially the same thickness, the first and second fuel electrodes 221 and 231 may include Ni and YSZ, and the first fuel electrode 221 may have a lower content ratio of Ni than the second fuel electrode 231. In addition, the materials of the first and second air electrodes 223 and 233 may be adjusted, and materials of the first and second air electrodes 223 and 233 may also be adjusted simultaneously or separately. Specifically, the first and second air electrodes 223 and 233 may include different types of materials. More specifically, the first air electrode 223 may include a LaMg-based ceramic having a relatively high operating temperature, e.g., LSM, and the second air electrode 233 may include a LaCo-based ceramic having a relatively low operating temperature, e.g., LSC.

In addition, as in the example of FIG. 10, the first and second electrolytes 222 and 232 may form an integral structure with each other, while the second electrolyte 233 may be thinner than the first electrolyte 232, and even with this form, the operating temperature of the first solid oxide cell 220 may be implemented to be higher than that of the second solid oxide cell 230.

The configuration to have the operating temperature of the first solid oxide cell to be higher than the operating temperature of the second solid oxide cell may be implemented by combining two or more of the above-discussed examples. For example, the example having the difference in thickness and the example having the difference in material composition may be combined so that the operating temperature of the first solid oxide cell may be higher than the operating temperature of the second solid oxide cell, although the present disclosure is not limited thereto. Some overlapped descriptions will be omitted to avoid redundancy.

In the case of the solid oxide cell stack according to an exemplary embodiment in the present disclosure, use efficiency of fuel and heat may be improved. Therefore, performance may be improved when the solid oxide cell stack is used as a fuel cell or an electrolysis cell.

While example exemplary embodiments have been illustrated and described above, it will be apparent to those skilled in the art that modifications and variations could be made without departing from the scope of the present disclosure as defined by the appended claims.

What is claimed is:

1. A solid oxide cell stack comprising:
a plurality of interconnects;
a first solid oxide cell disposed between the plurality of interconnects and including a first fuel electrode, a first electrolyte, and a first air electrode; and
a second solid oxide cell disposed to be adjacent to the first solid oxide cell in a lateral direction between the plurality of interconnects and including a second fuel electrode, a second electrolyte, and a second air electrode,
wherein an operating temperature of the first solid oxide cell is higher than an operating temperature of the second solid oxide cell.

2. The solid oxide cell stack of claim 1, wherein the operating temperature of the first solid oxide cell is 750° C. or higher, and the operating temperature of the second solid oxide cell is less than 750° C.

3. The solid oxide cell stack of claim 1, wherein the first solid oxide cell is an electrolyte-supported cell, and the second solid oxide cell is a fuel electrode-supported cell.

4. The solid oxide cell stack of claim 1, wherein the second electrolyte is thinner than the first electrolyte.

5. The solid oxide cell stack of claim 1, wherein the first and second fuel electrodes include Ni and YSZ.

6. The solid oxide cell stack of claim 5, wherein the first fuel electrode has a lower content ratio of Ni than the second fuel electrode.

7. The solid oxide cell stack of claim 6, wherein the first and second electrolytes have substantially a same thickness.

8. The solid oxide cell stack of claim 1, wherein the first and second air electrodes include different materials.

9. The solid oxide cell stack of claim 8, wherein the first air electrode includes a LaMg-based ceramic, and the second air electrode includes LaCo-based ceramics.

10. The solid oxide cell stack of claim 9, wherein the first and second electrolytes have substantially a same thickness.

11. The solid oxide cell stack of claim 1, wherein the first and second electrolytes are connected to each other to have an integral structure.

12. The solid oxide cell stack of claim 11, wherein the second electrolyte is thinner than the first electrolyte.

13. The solid oxide cell stack of claim 1, wherein, when a stacking direction of the plurality of interconnectors is referred to as a first direction, the first and second solid oxide cells are arranged to be adjacent to each other in a second direction, perpendicular to the first direction.

14. The solid oxide cell stack of claim 1, wherein the plurality of interconnects include first and second recesses in which the first and second solid oxide cells are respectively disposed.

15. The solid oxide cell stack of claim 14, wherein the first and second recesses are connected to each other.

16. The solid oxide cell stack of claim 14, wherein the first fuel electrode faces a bottom surface of the first recess, and the second fuel electrode faces a bottom surface of the second recess.

17. The solid oxide cell stack of claim 14, wherein the plurality of interconnects include a plurality of through-holes extending in a stacking direction of the plurality of interconnectors, and the plurality of through-holes are arranged outside the first and second recesses.

18. The solid oxide cell stack of claim 17, wherein some of the plurality of through-holes are connected to the first recess and the others thereof are connected to the second recess.

19. A solid oxide cell stack comprising:
a plurality of interconnects;
an electrolyte-supported first solid oxide cell disposed between the plurality of interconnects; and
a fuel electrode-supported second solid oxide cell disposed between the plurality of interconnects.

20. The solid oxide cell stack of claim 19, wherein when a stacking direction of the plurality of interconnectors is referred to as a first direction, the first and second solid oxide cells are disposed to be adjacent to each other in a second direction, perpendicular to the first direction.

21. A solid oxide cell stack comprising:
a plurality of interconnects;
a first solid oxide cell disposed between the plurality of interconnects and including a first fuel electrode, a first electrolyte, and a first air electrode arranged in a first direction; and
a second solid oxide cell disposed between the plurality of interconnects and including a second fuel electrode, a second electrolyte, and a second air electrode arranged in the first direction,
wherein the first solid oxide cell and the second solid oxide cell are disposed in a second direction crossing the first direction, and
the first solid oxide cell and the second solid oxide cell are different from each other at least in one of the following:
thickness between the first electrolyte and the second electrolyte,
material composition between the first fuel electrode and the second fuel electrode, and
material composition between the first air electrode and the second air electrode.

22. The solid oxide cell stack of claim 21, wherein the first and second fuel electrodes include Ni and YSZ, and
the first fuel electrode has a lower content ratio of Ni than the second fuel electrode.

23. The solid oxide cell stack of claim 22, wherein the first and second electrolytes have substantially a same thickness.

24. The solid oxide cell stack of claim 21, wherein the first air electrode includes a LaMg-based ceramic, and the second air electrode includes LaCo-based ceramics.

25. The solid oxide cell stack of claim 24, wherein the first and second electrolytes have substantially a same thickness.

26. The solid oxide cell stack of claim 21, wherein the first and second electrolytes are connected to each other to have an integral structure.

27. The solid oxide cell stack of claim 21, wherein the first and second electrolytes are spaced apart from each other.
